(19) United States
(12) Patent Application Publication
(10) Pub. No.: US 2023/0252656 A1
(43) Pub. Date: Aug. 10, 2023

(54) MEASUREMENT SYSTEM, MEASUREMENT METHOD, AND STORAGE MEDIUM

(71) Applicant: Kabushiki Kaisha Toshiba, Tokyo (JP)

(72) Inventor: Hiroaki Nakamura, Kawasaki Kanagawa (JP)

(21) Appl. No.: 18/063,917

(22) Filed: Dec. 9, 2022

(30) Foreign Application Priority Data
Feb. 8, 2022 (JP) 2022018091

(51) Int. Cl. G06T 7/33; G06T 7/60; G06V 10/762; G06V 10/56; G06V 10/60

(52) U.S. Cl. CPC G06T 7/337; G06T 7/60; G06V 10/762; G06V 10/56; G06V 10/60; G06T 2207/10024; G06T 2207/10028; G06T 2207/30204

(57) ABSTRACT

According to one embodiment, a measurement system includes a processor including a hardware. The processor extracts a point cloud of a first marker from a measurement point cloud. The first marker is arranged at a known position with respect to a measurement target. The measurement point includes a point cloud of the measurement target and the point cloud of the first marker. The processor aligns the point cloud of the measurement target with a known point cloud relating to the measurement target by aligning the point cloud of the first marker with a point cloud of a second marker associated with a known position with respect to the known point cloud.

### CROSS-REFERENCE TO RELATED APPLICATIONS

This application is based upon and claims the benefit of priority from the Japanese Patent Application No. 2022-018091, filed Feb. 8, 2022, the entire contents of which are incorporated herein by reference.

### FIELD

Embodiments described herein relate generally to a measurement system, a measurement method, and a storage medium.

### BACKGROUND

Conventionally, alignment of two point clouds is performed by deriving point cloud correspondence information presenting correspondence between each point present in one point cloud and its corresponding point in the other point cloud and by deriving geometric conversion information between the two point clouds.

If two point clouds have distinctive features, highly accurate alignment is performed by comparing features between the two point clouds. On the other hand, if two point clouds have few distinctive features, the accuracy of alignment therebetween is prone to decrease. For example, two point clouds that are different in position and attitude and that form a symmetric shape increase the possibility of deriving erroneous geometric conversion information that provides correspondence between the closest points.

### BRIEF DESCRIPTION OF THE DRAWINGS

FIG. 1 is a block diagram showing an exemplary configuration of a measurement system according to an embodiment.

FIG. 2 is a diagram showing a measurement marker.

FIG. 3 is a diagram showing a relationship between known point cloud data and point cloud data of a known marker.

FIG. 4 is a diagram showing an example of a hardware configuration of the measurement system.

FIG. 5 is a flowchart showing operation of the measurement system.

FIG. 6 is a diagram showing clustering.

FIG. 7 is a diagram showing multi-layering of point cloud data of a known marker.

### DETAILED DESCRIPTION

In general, according to one embodiment, a measurement system includes a processor including a hardware. The processor extracts a point cloud of a first marker from a measurement point cloud. The first marker is arranged at a known position with respect to a measurement target. The measurement point includes a point cloud of the measurement target and the point cloud of the first marker. The processor aligns the point cloud of the measurement target with a known point cloud relating to the measurement target by aligning the point cloud of the first marker with a point cloud of a second marker associated with a known position with respect to the known point cloud.

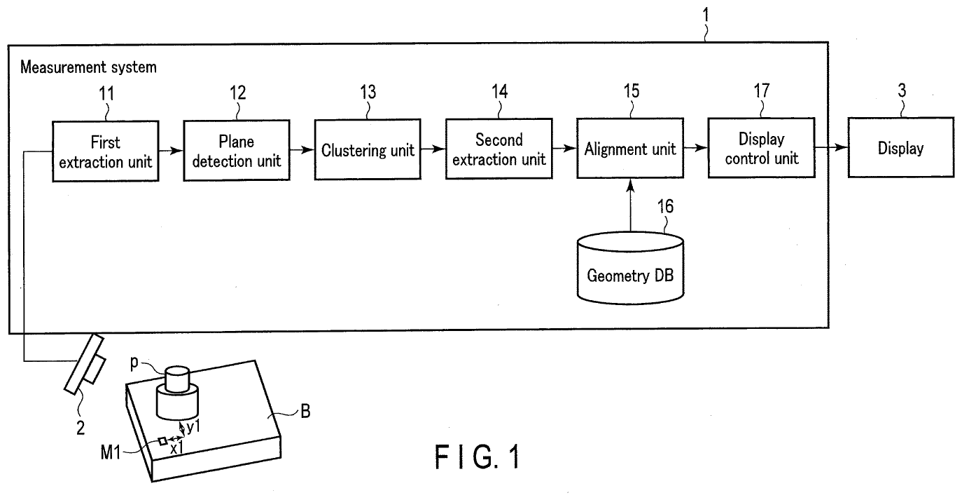

Hereinafter, embodiments will be described with reference to the drawings. FIG. 1 is a block diagram showing an exemplary configuration of a measurement system according to an embodiment. A measurement system 1 shown in FIG. 1 is usable for measurement in a component assembling system. A measurement target of the measurement system 1 is a component p placed on, for example, a base plate B for assembly. The measurement system 1 in the embodiment compares a point cloud of the component p that is measured by a camera 2 with a known point cloud that is prepared in advance and relates to the component p, and presents a result of the comparison to a user. The user is, for example, a worker who checks whether or not the component p is correctly assembled.

The base plate B is a flat plate provided with, for example, a holding part for holding the component p at a predetermined position. A measurement marker M1 is arranged on the base plate B. The measurement marker M1 is a marker having a known size, which is arranged in a predetermined orientation at a predetermined position of the base plate B. The size information of the measurement marker M1 may include information such as the length of each side of the measurement marker M1 and the length of the diagonal line. In the embodiment, the component p is placed on the base plate B in such a manner that a positional relationship between the component p and the measurement marker M1 becomes a predetermined and known positional relationship. In FIG. 1, a horizontal distance between the component p and the measurement marker M1 on the plane of the base plate B is x1, and a vertical distance is y1. The base plate B may be a workbench, etc., on which the assembly work of the component p is carried out. The base plate B may be a substrate, etc., on which an electronic circuit is mounted.

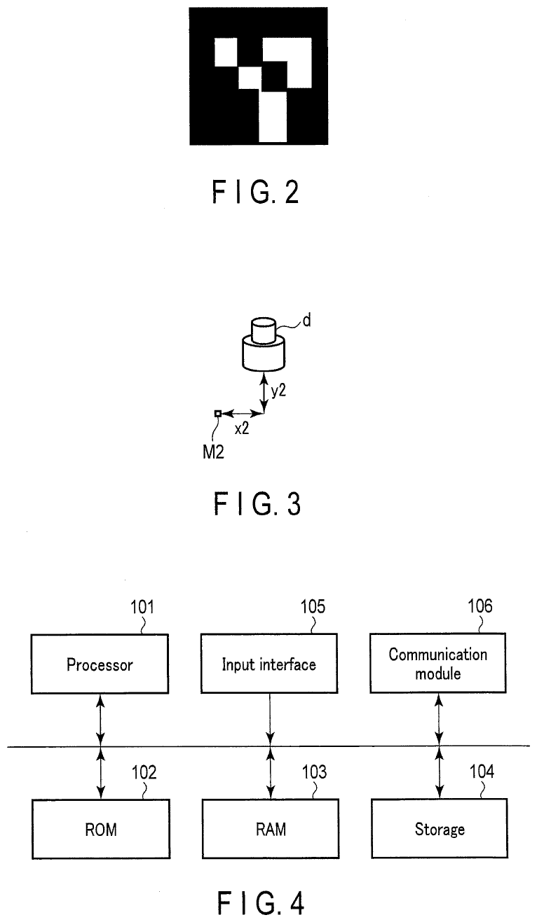

The measurement marker M1 is, for example, an augmented reality (AR) marker, and is recognizable from an image acquired by the camera 2. The measurement marker M1 is, for example, a planar marker in a quadrilateral shape having a black and white pattern. FIG. 2 is a diagram showing the measurement marker M1. As shown in FIG. 2, it is desirable that the measurement marker M1 have an asymmetric pattern in the left-right direction and the up-down direction. Because of the measurement marker M1 having the asymmetric pattern, the orientation of the measurement marker M1 in an image is recognizable. Two or more measurement markers M1 may be arranged on the base plate B. The shape of the measurement marker M1 is not necessarily a quadrilateral shape.

As shown in FIG. 1, the measurement system 1 has a first extraction unit 11, a plane detection unit 12, a clustering unit 13, a second extraction unit 14, an alignment unit 15, a geometry database (DB) 16, and a display control unit 17. The measurement system 1 is configured to be communicable with the camera 2. The communication between the measurement system 1 and the camera 2 may be either wireless or wired. The measurement system 1 is configured to be communicable with the display 3. The communication between the measurement system 1 and the display 3 may be either wireless or wired. In FIG. 1, the first extraction unit 11, the plane detection unit 12, the clustering unit 13, and the second extraction unit 14 form an extraction unit for extracting a point cloud of the measurement marker M1.

The camera 2 is, for example, a camera gripped by the user and configured to measure measurement point cloud data including a point cloud of the measurement marker M1 and the component p serving as a measurement target (hereinafter, also referred to as a “measurement target component p”) together with an image of the measurement marker M1 and the measurement target component p. The camera 2 may be a depth camera or a 3D scanner. For example, an RGB-D camera is usable as the camera 2. An RGB-D camera is a camera configured to measure an RGB-D image. An RGB-D image includes a depth image and a color image (RGB color image). A depth image is an image that contains a depth of each point of a measurement target as a pixel value. A color image is an image that contains an RGB value of each point of a measurement target as a pixel value.

The display 3 is a display such as a liquid crystal display or an organic EL display. The display 3 displays various types of images based on data transferred from the measurement system 1.

The first extraction unit 11 extracts point cloud data having a color similar to that of the measurement marker M1 from the measurement point cloud data measured by the camera 2. For example, in the case of the measurement marker M1 being a marker having a black and white pattern, the first extraction unit 11 compares an RGB value of each pixel of the color image measured by the camera 2 with the upper limit value corresponding to a black color, thereby specifying a pixel of an RGB value below the upper limit value as a black pixel. The first extraction unit 11 then extracts point cloud data corresponding to the black pixel from the measurement point cloud data.

The plane detection unit 12 detects a plane formed by the point cloud data extracted by the first extraction unit 11, and extracts point cloud data on a plane from the point cloud data extracted by the first extraction unit 11. Plane detection may be performed using, for example, Random Sample Consensus (RANSAC) plate fitting. RANSAC plate fitting utilizes RANSAC, which removes an outlier based on a fundamental matrix calculated from randomly sampled points in point cloud data. RANSAC plate fitting groups respective points of the point cloud data into two segments, an inlier set and an outlier set, by using RANSAC, thereby detecting the plane formed using points belonging to the inlier. Plane detection may be performed by a discretionary method other than RANSAC plate fitting, such as a method using a Hough transform. By the plane detection, point cloud data extracted by the first extraction unit 11 is narrowed down to point cloud data on a plane.

The clustering unit 13 clusters point cloud data on a plane detected by the plane detection unit 12. Clustering is performed using, for example, density-based spatial clustering of applications with noise (DBSCAN). DBSCAN is a method that determines that an evaluation point and its neighboring points belong to the same cluster if the number of points in the vicinity of the evaluation point in point cloud data exceeds a certain amount, and that the evaluation point and its neighboring points do not belong to the same cluster if the aforementioned number does not exceed the certain amount, and the method repeatedly makes this determination while changing the evaluation point to thereby cluster point cloud data. If the point cloud data of the component p and the point cloud data of the measurement marker M1 are distant from each other as in the embodiment, there is a high probability that each piece of point cloud data of the measurement marker M1 belongs to the same cluster. Clustering may be performed by a discretionary method other than DBSCAN, such as k-means, etc.

The second extraction unit 14 extracts point cloud data of the measurement marker M1 from a cluster obtained by the clustering unit 13. If the size of the measurement marker M1 is known, the point cloud data of the measurement marker M1 may be specified from, for example, the length of the diagonal line of the boundary box of the point cloud. The boundary box of the point cloud is a region formed by a boundary of each cluster. That is, the second extraction unit 14 extracts, as point cloud data of the measurement marker M1, point cloud data belonging to a cluster in which the length of a diagonal line of a boundary box of a point cloud is closest to the length of a diagonal line of the measurement marker M1. The point cloud data of the measurement marker M1 may be extracted based on, e.g., the length of a side of the boundary box other than the diagonal line.

The alignment unit 15 performs alignment of point cloud data of a measurement target with known point cloud data stored in the geometry DB 16 by aligning point cloud data of the measurement marker M1 extracted by the second extraction unit 14 and point cloud data of the known marker M2 stored in the geometry DB 16. The alignment may be performed using an iterative closest point (ICP) method, a Bayesian coherent point drift (BCPD) method, etc.

The geometry DB 16 stores known point cloud data of the measurement target. The known point cloud data may be design drawing data, etc., of the measurement target component p obtained by 3D computer aided design (3D CAD). The known point cloud data is not limited to the aforementioned design drawing data, and may be discretionary point cloud data or data that can be converted into point cloud data.

The geometry DB 16 stores point cloud data of the known marker M2 together with known point cloud data. Point cloud data of the known marker M2 is point cloud data of a marker having the same black-and-white pattern as that of the measurement marker M1, and is point cloud data in which a predetermined position and a predetermined orientation are associated with known point cloud data. In the case where two or more measurement markers M1 are arranged on the base plate B, point cloud data of two or more known markers M2 may be prepared.

FIG. 3 is a diagram showing a relationship between known point cloud data and point cloud data of the known marker M2. The embodiment assumes that known point cloud data d of the component p and point cloud data of the known marker M2 are arranged in a predetermined orientation on the same virtual plane. Then, the known point cloud data d and the point cloud data of the known marker M2 are associated with data presenting their positional relationship on the virtual plane. The data presenting the positional relationship includes data on a horizontal distance x2 and data on a vertical distance y2 on the virtual plane in which the known point cloud data d of the component p and the point cloud data of the known marker M2 are arranged. The horizontal distance x2 is a distance that is k1 (k1 is a positive real number) times the horizontal distance x1, and the vertical distance y2 is a distance that is k2 (k2 is a positive real number) times the vertical distance y1. k1 and k2 may be or may not be equal. That is, the positional relationship between the measurement target component p and the measurement marker M1 may be different from the positional relationship between the known point cloud data d and the known marker M2.

The number of points in the known point cloud data is not necessarily made equal to the number of points in the point cloud data of the measurement target. On the other hand, it is desirable that the number of points in the point cloud data of the known marker M2 be made equal to the number of points in the point cloud data of the measurement marker M1. That is, the known point cloud data and the point cloud data of the measurement target may be different in density; however, the point cloud data of the known marker M2 and the point cloud data of the measurement marker M1 are desirably equal in density. This is because, as will be described in detail later, in the embodiment, alignment of the measurement point cloud data with the known point cloud data is performed by aligning the measurement marker M1 and the known marker M2. For accurate alignment of the measurement marker M1 with the known marker M2, it is desirable that both markers be made equal in the number of points.

The known point cloud data and the point cloud data of the known marker may be configured as separate pieces of point cloud data. Even in such a case, the horizontal distance x2 and the vertical distance y2 which represent the positional relationship between the known point cloud data and the point cloud data of the known marker are defined. As a matter of course, the known point cloud data and the point cloud data of the known marker may be configured as one piece of point cloud data.

Furthermore, the geometry DB 16 may be provided outside the measurement system 1. In such a case, the alignment unit 15 of the measurement system 1 acquires information from the geometry DB 16 as necessary.

The display control unit 17 causes the display 3 to display information relating to a result of the alignment by the alignment unit 15. The information relating to a result of comparison of geometry is, for example, an image obtained by superposing an image based on a known point cloud stored in the geometry DB 16 on an image based on a point cloud measured with the camera 2. The superposition of images may be performed by moving one image to the other image based on the geometric transformation information obtained by the alignment using the alignment unit 15.

FIG. 4 is a diagram showing an example of the hardware configuration of the measurement system 1. The measurement system 1 may be a terminal device of various types, such as a personal computer (PC), a tablet terminal, etc. As shown in FIG. 2, the measurement system 1 includes a processor 101, a ROM 102, a RAM 103, a storage 104, an input interface 105, and a communication module 106 as hardware.

The processor 101 is a processor that controls the overall operation of the measurement system 1. The processor 101 executes, for example, programs stored in the storage 104, thereby operating as the first extraction unit 11, the plane detection unit 12, the clustering unit 13, the second extraction unit 14, the alignment unit 15, and the display control unit 17. The processor 101 is, for example, a central processing unit (CPU). The processor 101 may be, for example, a microprocessing unit (MPU), a graphics processing unit (GPU), an application-specific integrated circuit (ASIC), a field-programmable gate array (FPGA), etc. The processor 101 may be, for example, either a single CPU or a plurality of CPUs.

The read-only memory (ROM) 102 is a non-volatile memory. The ROM 102 stores an activation program, etc. of the measurement system 1. The random access memory (RAM) 103 is a volatile memory. The RAM 103 is used as, for example, a working memory during the processing at the processor 101.

The storage 104 is, for example, a storage such as a hard disk drive or a solid-state drive. The storage 104 stores various types of programs executed by the processor 101, such as a measurement program. The storage 104 may store the geometry DB 16. The geometry DB 16 is not necessarily stored in the storage 104.

The input interface 105 includes input devices such as a touch panel, a keyboard, and a mouse. When an operation is performed on an input device of the input interface 105, a signal corresponding to a content of the operation is input to the processor 101. The processor 101 performs various types of processing in response to this signal.

The communication module 106 is a communication module for allowing the measurement system 1 to communicate with external devices such as the camera 2 and the display 3. The communication module 106 may be a communication module for either wired or wireless communications.

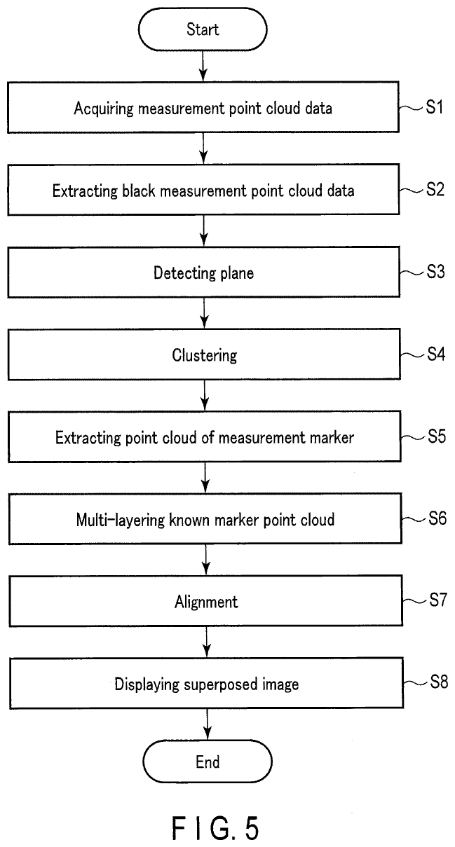

Next, an operation of the measurement system 1 will be described. FIG. 5 is a flowchart showing the operation of the measurement system 1. The processing of FIG. 5 is executed by the processor 101.

At step S1, the processor 101 acquires measurement point cloud data including point cloud data of the measurement marker M1 and the measurement target component p from the camera 2. Herein, at the time of measuring the measurement point cloud data using the camera 2, the measurement is performed in such a manner that both the measurement target component p and the measurement marker M1 are included in the field of view of the camera 2.

At step S2, the processor 101 extracts, for example, black measurement point cloud data from the measurement point cloud data acquired from the camera 2. In the case where the component p contains no black portion and the measurement marker M1 is a black-and-white pattern marker, only the point cloud data of the measurement marker M1 is extracted by such processing. However, in the case of the component p containing a black portion or a low-luminance portion regarded as a black portion, point cloud data of the black portion or the low-luminance portion of the component p may also be extracted. The rest of the processing is performed in consideration of the case in which the component p contains a black or low-luminance portion.

At step S3, the processor 101 detects a plane formed by the extracted point cloud and extracts point cloud data on the plane. Plane detection is performed in order to consider the tilt of point cloud data depending on, for example, a shooting direction of the camera 2. The rest of the processing is performed on the extracted point cloud data on the plane.

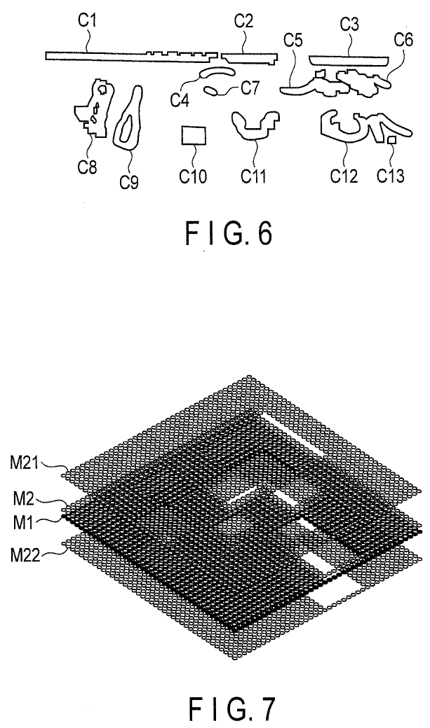

At step S4, the processor 101 clusters each detected piece of point cloud data on a plane. As a result of clustering, the black measurement point cloud data extracted at step S2 is divided into a plurality of clusters C1, C2, . . . , Cn (n=13 in FIG. 6) as shown in FIG. 6. In FIG. 6, for example, the cluster C10 is a cluster of point cloud data of the measurement marker M1. Meanwhile, FIG. 6 shows a result of clustering with respect to point cloud data on one plane. In practice, clustering is performed on each piece of point cloud data on each plane detected in step S3.

At step S5, the processor 101 extracts point cloud data of the measurement marker M1 from the size of a boundary box of each piece of point cloud data. The processor 101, for example, extracts as point cloud data of the measurement marker M1, point cloud data in which the length of a diagonal line of a boundary box is closest to the length of a diagonal line of the measurement marker M1. It is also assumed that a component whose boundary box has the same shape as that of the marker M1 is arranged on the base plate B. Considering this, the length of a diagonal line of the measurement marker M1 needs to be different from the length of a diagonal line of every component that is supposed to be arranged on the base plate B. By making the length of a diagonal line of the measurement marker M1 different from the length of a diagonal line of each component, only the point cloud data of the measurement marker M1 can be correctly extracted.

At step S6, the processor 101 virtually multi-layers the point cloud data of the known marker M2 stored in the geometry DB 16. For example, as shown in FIG. 7, the multi-layering is performed by generating a plurality of duplicate point cloud data M21 and M22 of the point cloud data of the known marker M2 at positions moved by a certain distance along the normal direction with respect to the surface of the point cloud data of the original known marker M2 stored in the geometry DB 16. Herein, the number of pieces of replication point cloud data is not limited to two. That is, three or more pieces of point cloud data may be generated.

At step S7, the processor 101 performs the alignment of the point cloud data of the component p with the known point cloud data by aligning the point cloud data of the measurement marker M1 extracted in step S5 with the point cloud data of the known marker M2 multi-layered at step S6. The measurement point cloud data may be rotated around the normal direction due to, e.g., the tilt of the camera 2 at the time of shooting. The measurement point cloud data may be tilted due to, e.g., the tilt of the camera 2 at the time of shooting. In these cases, even if the point cloud data of the measurement marker M1 and the point cloud data of the known marker M2 are aligned, the amount of information in the three-dimensional direction may not be enough to perform the alignment correctly. As shown in FIG. 7, the alignment of the multi-layered point cloud data of the known marker M2 with the point cloud data of the measurement marker M1 may compensate for the lack of information on the three-dimensional direction at the time of alignment. Thus, the point cloud data of the measurement marker M1 and the point cloud data of the known marker M2 are aligned correctly. Herein, the positional relationship between the measurement marker M1 and the measurement target component p and the positional relationship between the point cloud data of the known marker M2 and the known point cloud data are determined in advance. Thus, the alignment of the point cloud data of the measurement marker M1 with the point cloud data of the known marker M2 enables the point cloud data of the component p and the known point cloud data to be aligned correctly. If the positional relationship between the measurement target component p and the measurement marker M1 is different from the positional relationship between the known point cloud data d and the known marker M2, the alignment of the point cloud data of the component p with the known point cloud data is performed in accordance with the difference between these relationships.

At step S8, the processor 101 superposes a three-dimensional image of the measurement target based on the measurement point cloud data measured by the camera 2 on a three-dimensional image of the measurement target based on the known point cloud data, and displays the superposed image on the display 3. Thereafter, the processor 101 terminates the processing in FIG. 5. When displaying data in a superposing manner, the difference between the measurement point cloud data and the known point cloud data may be emphasized. The emphasis may be performed by a discretionary method such as changing the color of a portion corresponding to the difference, changing the density of a position corresponding to the difference, etc.

As described above, according to the embodiment, the measurement marker M1 is provided at a known position from a measurement target, while a point cloud of the known marker M2 is provided at a known position from a known point cloud relating to the measurement target. Thus, the point cloud data of the measurement target and the known point cloud data are aligned by the alignment of point cloud data of the measurement marker M1 extracted from measurement point cloud data with point cloud data of the known marker M2. That is, information on a feature amount of the measurement target is not used for the alignment of the point cloud data of the measurement target with the known point cloud data. This enables accurate alignment to be performed even in the case of a measurement target having no distinctive features.

Furthermore, according to the embodiment, in order to extract the point cloud data of the measurement marker M1 from the measurement point cloud data, extraction of the point cloud data of the same color as the measurement marker M1, plane detection, clustering, and extraction of the point cloud data according to a size of a diagonal line of the boundary box are performed. In this manner, only the point cloud data of the measurement marker M1 can be correctly extracted. This makes it possible in the present embodiment to extract the point cloud data of the measurement marker M1 with high accuracy even in the case where an image of the measurement marker M1 with sufficient resolution cannot be obtained due to the performance of the camera 2.

Furthermore, at the time of alignment, the point cloud data of the known marker M2 is multi-layered. This makes it possible to perform accurate alignment covering the three-dimensional direction.
(Modification)

A modification will be described. The embodiment assumes that the measurement system 1 is used for measurement in a component assembly system. However, the measurement system according to the embodiment is applicable to a discretionary measurement system.

Furthermore, the camera 2 may be integrally configured with the measurement system 1. In this case, control of the position and attitude of the camera 2 may be performed by the measurement system 1.

Furthermore, the embodiment assumes that the measurement marker M1 is a black-and-white pattern marker. However, the measurement marker M1 is not necessarily a black-and-white pattern marker. For example, the measurement marker M1 may be a marker having a predetermined color pattern. In such a case, the first extraction unit 11 compares an RGB value of each pixel of a color image measured by the camera 2 with the upper limit value and the lower limit value corresponding to the color of the marker M1, thereby specifying a pixel of an RGB value above the lower limit value and below the upper limit value. The first extraction unit 11 then extracts the point cloud data corresponding to the specified pixel from the measurement point cloud data.

The measurement marker M1 may be a marker that is recognized by the luminance. For example, the measurement marker M1 may be a black-and-white pattern marker drawn with retroreflective paint. In such a case, a Light Detecting and Ranging (LiDAR) camera may be used as the camera 2. The first extraction unit 11 extracts the measurement point cloud data of the measurement marker M1 from the measurement point cloud data based on information on the infrared luminance of a measurement target measured by the camera 2. Specifically, the first extraction unit 11 extracts point cloud data whose luminance value is higher than a predetermined value. This is because high-luminance infrared light is returned because of a retroreflective mechanism from a marker drawn with retroreflective paint. The measurement marker M1 drawn with retroreflective paint is measurable by a camera other than the LiDAR camera such as an RGB-D camera.

Furthermore, the embodiment assumes that the measurement target has a three-dimensional structure. However, in the case where the three-dimensional information is not required for the alignment, such as the case where the measurement target is a plane, the processing such as the plane detection and the multi-layering of the point cloud data of the known marker M2 may be omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement system comprising: a processor including a hardware, the processor configured to:
extract a point cloud of a first marker from a measurement point cloud, the first marker arranged at a known position with respect to a measurement target, the measurement point including a point cloud of the measurement target and the point cloud of the first marker; and
align the point cloud of the measurement target with a known point cloud relating to the measurement target by aligning the point cloud of the first marker with a point cloud of a second marker associated with a known position with respect to the known point cloud.

2. The measurement system according to claim 1, wherein the processor
extracts a first point cloud having a color similar to that of the first marker from the measurement point cloud;
clusters the first point cloud; and
extracts, as the point cloud of the first marker, a second point cloud having a size corresponding to a size of the first marker, from the clustered first point cloud based on information on a size of the first marker.

3. The measurement system according to claim 1, wherein the processor
extracts a first point cloud having a luminance similar to that of the first marker from the measurement point cloud;
clusters the first point cloud; and
extracts, as the point cloud of the first marker, a second point cloud having a size corresponding to a size of the first marker, from the clustered first point cloud based on information on the size of the first marker.

4. The measurement system according to claim 2, wherein the processor is further configured to detect at least one plane corresponding to the first point cloud, and clusters the first point cloud on the plane.

5. The measurement system according to claim 2, wherein the information on the size is a length of a diagonal line of the first marker.

6. The measurement system according to claim 2, wherein the first marker and the second marker are planar markers, and
the processor is further configured to:
multi-layer the point cloud of the second marker by duplicating the point cloud of the second marker along a normal direction of a plane of the second marker; and
align the second point cloud with the multi-layered point cloud of the second marker.

7. The measurement system according to claim 3, wherein the first marker is a marker drawn with retroreflective paint.

8. A measurement method comprising:
extracting a point cloud of a first marker from a measurement point cloud, the first marker arranged at a known position with respect to a measurement target, the measurement point including a point cloud of the measurement target and the point cloud of the first marker; and
aligning the point cloud of the measurement target with a known point cloud relating to the measurement target by aligning the point cloud of the first marker with a point cloud of a second marker associated with a known position with respect to the known point cloud.

9. A computer-readable non-transitory storage medium that stores a measurement program for causing a computer to execute:
extracting a point cloud of a first marker from a measurement point cloud, the first marker arranged at a known position with respect to a measurement target, the measurement point including a point cloud of the measurement target and the point cloud of the first marker; and
aligning the point cloud of the measurement target with a known point cloud relating to the measurement target by aligning the point cloud of the first marker with a point cloud of a second marker associated with a known position with respect to the known point cloud.
